(19) United States
(12) Patent Application Publication
(10) Pub. No.: US 2025/0264579 A1
(43) Pub. Date: Aug. 21, 2025

(54) METHOD FOR SELF-CALIBRATION OF A RADAR SYSTEM

(71) Applicant: Robert Bosch GmbH, Stuttgart (DE)

(72) Inventors: Johannes Fink, Karlsruhe (DE); Juergen Hasch, Stuttgart (DE); Martin Fink, Leonberg (DE)

(21) Appl. No.: 18/859,361

(22) PCT Filed: Jun. 27, 2023
(86) PCT No.: PCT/EP2023/067473

§ 371 Date: Oct. 23, 2024

(30) Foreign Application Priority Data
Sep. 2, 2022 (DE) 10 2022 209 121.3

(51) Int. Cl. G01S 7/40; G01S 13/08

(52) U.S. Cl. CPC G01S 7/4008; G01S 7/4021; G01S 13/08

(57) ABSTRACT

A method for self-calibration of a radar system which includes at least two antenna groups to which a transmission channel and a receiving channel are assigned. Targets are measured by the radar system. The range and Doppler information is processed for each antenna group, and the targets are detected to obtain reflection lists with complex amplitudes for each target. A compensation of the amplitude differences for the respective channels is performed. A two-dimensional linear regression is used to estimate a regression plane, and the difference between the measured phase value and the regression plane is calculated for each channel to obtain an intragroup phase correction value. A distance between two regression planes of different antenna groups is calculated with modulo 21 to obtain an intergroup phase correction value. The control vector of each channel is compensated with the intragroup phase correction value and the intergroup phase correction value.

### FIELD

The present invention relates to a method for self-calibration of a radar system comprising at least two antenna groups. At least one transmission channel and one receiving channel are assigned to the antenna groups.

### BACKGROUND INFORMATION

Radar systems are used to measure distance, relative speed, and azimuth and elevation angles of objects. Angle estimation typically involves the use of antenna groups, also referred to as antenna arrays, that can be used for both transmitting and receiving. The angle of incidence of a reflected plane wave as is generated by targets in the far field is acquired by means of digital beamforming. For beamforming, the phase differences of the reflected wave are evaluated across the multiple receiving channels. The reception signals of the antenna groups can be treated by transformation as if they had been measured by virtual receivers. The evaluation is traditionally carried out via previously stored control vectors that are used in different methods. In the Bartlett beamformer, for instance, the expected differential phases for different angles of incidence are stored in the control vectors, which are then correlated. Alternatively, model-based estimates can be carried out, which are likewise based on the control vectors.

Traditionally, the control vectors are measured across the angle (one or more angle slices) for each individual sensor during a one-time end-of-line calibration and then stored in a non-volatile memory. This takes into account a phase error (phase offset) that can occur as a result of various effects, such as manufacturing tolerances of antennas or feed lines, or an interaction of the electromagnetic waves with a radome, a housing or a circuit board.

The antenna groups also make it possible to divide the surroundings into angle cells and acquire said angle cells separately from one another. This allows targets, the range and radial speed of which are identical, to be separated from one another via their angular position. Each radar beam of the radar system represents a spatial filter.

For the specific functions in vehicle automation, better angle measurements in terms of both accuracy and separation capability are needed. To achieve this, antenna groups with a large aperture are used. These are typically grouped and cascaded to control the corresponding transceivers, which creates a transceiver hierarchy. In order to carry out a coherent measurement of the angle of incidence of the reflected wave, all of the transceivers are preferably connected to a reference oscillator. High-frequency lines that distribute the signal of the reference oscillator to the transceivers. are typically used for this purpose. The larger the aperture, however, the longer the high frequency lines.

Nowadays, patch antennas are commonly used as radar antennas in the automotive sector. The patch antennas are applied to the surface of a circuit board and provided with striplines. As a result, the size of the circuit boards increases in proportion to the size of the aperture. In large circuit boards, the probability of an inhomogeneous temperature distribution on the circuit board, which is caused by internal and/or external influencing factors, increases as well. One example of internal influencing factors is the strong heating of different component groups. Examples of external influencing factors include partial shading of the circuit board and heating due to neighboring assemblies and/or due to air currents.

The inhomogeneous temperature distribution as well as the aging of the components and other factors affect the measurement of the radar system by changing the previously calibrated phase errors. If the angle estimation continues to be carried out with the initially stored control vectors, the performance of the angle estimation is reduced. In particular the side lobes increase in the angular spectrum, while the main lobe is attenuated and widened and the position of the main lobe changes (beam-pointing error). As a result, the dynamic range, the accuracy and the separation capability of the angle estimation are reduced.

A self-calibration of a radar system is described in the article M. Harter et al., “Error analysis and self-calibration of a digital beamforming radar system”, 2015 IEEE MTT-S International Conference on Microwaves for Intelligent Mobility (ICMIM), 2015, pp. 1-4. This assumes that the wave fronts of the reflected wave at the antennas are flat. This assumption is sufficiently fulfilled only if the target is in the far field. The limit for the far field is typically defined using Formula 1 via the aperture length D and the wavelength:

$$R \geq \frac{2 {D}^{2}}{λ} \qquad ( Formula 1 )$$

Assuming that the target is in the far field, a one-dimensional linear regression is carried out from the received phases at the antenna elements of the receive antenna groups and the most probable course of the wave front is estimated. This is then used to calculate the phase errors to be corrected. The phase errors estimated from a target apply to the respective target angle without loss of generality. It is irrelevant whether the radar system comprises a radome or is disposed behind a bumper, for example.

Another prerequisite for self-calibration according to the above-mentioned article is that the antenna elements are arranged equidistantly along one dimension. This provides the following arrangement: To calibrate the azimuth control vectors, the antenna elements are arranged horizontally and to calibrate the elevation control vectors, the antenna elements are arranged vertically.

Self-calibration can generally be used for a variety of modulation methods. Typical transmission frequencies nowadays are 24 GHz or 77 GHz and the maximum bandwidths that can be occupied are below 4 GHz, in particular around 0.5 GHZ. Present-day radar systems in the automotive sector typically use FMCW modulation (frequency-modulated continuous wave radar) with fast ramps (fast chirp modulation), in which multiple linear frequency ramps having the same slope are transmitted in succession. Mixing the instantaneous transmitted signal with the received signal produces a low-frequency signal, the frequency (referred to as beat frequency) of which is proportional to the distance. The system is usually designed in such a way that the part of the beat frequency caused by the Doppler frequency is negligible. The distance information obtained from the beat frequency is largely unambiguous; a Doppler shift can then be determined by observing the time evolution of the phase of the complex range signal across the ramps. The distance and speed are determined independently of one another; usually using a two-dimensional Fourier transformation. The above-described angle estimation is downstream of the distance and speed estimation.

### SUMMARY

A method for self-calibration of a radar system (RS) comprising at least two antenna groups, to which at least one transmission channel and one receiving channel are assigned, is provided. The geometry of the antenna groups, i.e. the position of the transmit and receive antennas, is known. The transceiver hierarchy of the transceivers used to form the antenna groups, the elements of which experience similar phase errors, is known as well. These data are part of the specification of the radar system.

According to an example embodiment of the present invention, to start, a plurality of targets are measured by the radar system. For this purpose, transmit antenna groups emit electromagnetic waves in the direction of the targets. The electromagnetic waves reflected by the targets are then picked up by receive antenna groups and evaluated by means of digital beamforming. The measurement is resolved by angle, in which case the surroundings are divided into angle cells by the antenna groups.

The range and Doppler information is processed for each antenna group (also referred to as range-Doppler processing). The processing is preferably carried out using a two-dimensional fast Fourier transformation, but can also be carried out using other conventional algorithms. After that, the targets in the angle cells are detected. The following steps are preferably carried out for this purpose: For each angle cell, the energy is ascertained. A threshold value for the estimated noise energy of such an angle cell is estimated as well. The ascertained energy is compared to the threshold value for the noise energy, thus discriminating the ascertained energy in each cell against the estimated noise energy. If multiple adjacent angle cells are above the threshold value for the estimated noise energy, the local maximums of the measured complex data are determined for each combination of the transmitters and the receivers. The above steps result in reflection lists, in which the range, the relative speed and the complex amplitudes measured at the respective virtual channels are stored for each target.

According to an example embodiment of the present invention, first, the amplitude differences for the respective channels are compensated. The following steps are preferably carried out for this purpose. The average receive power across all signal amplitudes is calculated, in particular using Formula 2:

$$\vert \overline{x} \vert = \frac{1}{MN} {\sum }_{m = 1}^{M} {\sum }_{n = 1}^{N} \vert {\tilde{x}}_{mn} \vert \qquad ( Formula 2 )$$

|x̅| is the mean value of the amplitudes and \tilde{x}ₘₙ is the individual measured complex amplitudes. The totals across the transmitters m=1 . . . M and the receivers n=1 . . . N are summed.

The deviation of the amplitude from the average receive power is then calculated for each channel. The deviation is in particular calculated using a quotient according to Formula 3:

$${\hat{A}}_{mn} = \frac{\vert {\tilde{x}}_{mn} \vert}{\vert \overline{x} \vert} \qquad ( Formula 3 )$$

The deviation is then used to compensate an amplitude error for each channel. This step makes it possible to calibrate the receive power.

After this, an intragroup calibration is carried out for each antenna group. For this purpose, a two-dimensional linear regression is carried out for each antenna group. The regression plane for which the mean square distance of the phase measurement values of the channels of the antenna groups becomes minimal is estimated. The geometry data of the antenna groups, which, as described above, are known as part of the specification of the radar system, are used in the two-dimensional regression. The difference between the measured phase value and the regression plane is now calculated for each channel. This provides the intragroup phase correction value for the respective antenna group. This step is now repeated for all of the antenna groups, so that intragroup phase correction values are available for all of the (virtual) channels.

If the phase error is not angle-dependent (for example if the phase fields are based on aging of the radar system), the measured values of all targets can be averaged for each channel. This results in an averaging gain. If the phase error is angle-dependent (for example, because the radar system is disposed behind a bumper), each angle can be calibrated using a separate target. Intermediate angles for which there is no separate target can preferably be interpolated. The angles for which targets are available should be close enough to one another so that the sampling theorem is observed for the phase error. Running several measurement cycles one after the other makes it possible to acquire targets in angle cells that were previously only interpolated or for which a phase error estimation was not yet possible.

After this, an intergroup calibration is carried out for at least two different antenna groups in order to determine the phase error between the different antenna groups. A regression plane was ascertained for each antenna group as described above. The distance between two regression planes of two different antenna groups is now calculated using modulo 2π. This provides the intergroup phase correction value for the two antenna groups. If the regression planes are compensated with the intergroup phase correction value, all of the regression planes of the antenna groups are on top of one another.

Lastly, the control vectors of each channel are compensated with the intragroup phase correction value and the intergroup phase correction value. An angle estimation can then be carried out using a conventional method.

Because of the two-dimensional regression, the method can generally be applied to all geometries of the antenna groups and they are not subject to any limitations in terms of orientation or in terms of distance. The antenna groups therefore do not necessarily have to be arranged horizontally or vertically, but can be freely positioned. The antenna elements also do not have to be positioned equidistant from one another, but can be at any distance from one another. The phase errors for each channel moreover do not have to be distributed in the same way; rather a different average phase error is possible for each antenna group. The method can also be used for multiple-input multiple-output (MIMO) radar sensors.

### BRIEF DESCRIPTION OF THE DRAWINGS

Embodiment examples of the present invention are shown in the figures and explained in more detail in the following description.

FIG. 1 shows a schematic illustration of an example antenna of a radar system in which the method according to the present invention is being used.

FIG. 2 shows a flowchart of an example embodiment of the method according to the present invention.

### DETAILED DESCRIPTION OF EXAMPLE EMBODIMENTS

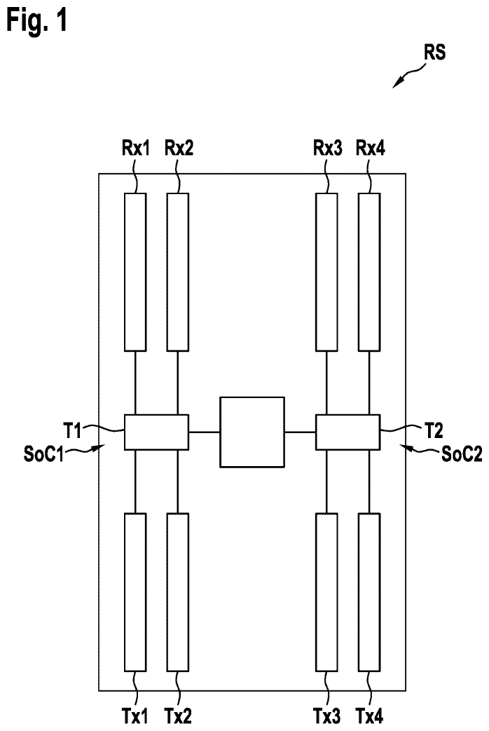

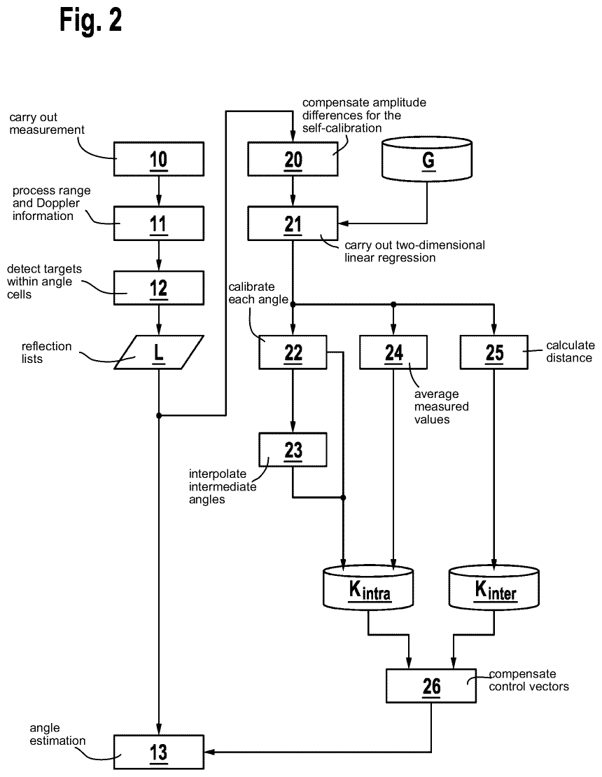

FIG. 1 shows an antenna of a radar system RS (not shown in further detail), in which the method according to the present invention is being used. The antenna comprises a plurality of antenna elements Rx1, Rx2, Rx3, Rx4, Tx1, Tx2, Tx3, and Tx4 that emit a radar signal as transmit antenna elements Tx1, Tx2, Tx3, and Tx4 and receive a reflected radar signal as receive antenna elements Rx1, Rx2, Rx3, Rx4. This is therefore a MIMO antenna (multiple-input multiple-output). Transceivers T1 and T2 are provided as well, to which the antenna elements Rx1, Rx2, Rx3, Rx4, Tx1, Tx2, Tx3 and Tx4 are connected. A first system on a chip SoC1 (also referred to as system-on-chip, SoC) consists of a first transceiver T1, as well as two transmit antenna elements Tx1, Tx2 and two receiver antenna elements Rx1, Rx2 which are all connected to said transceiver. A second system on a chip SoC2 consists of a second transceiver T2, as well as two transmit antenna elements Tx3, Tx4 and two receiver antenna elements Rx3, Rx4 which are all connected to said transceiver. The transmit antenna elements Tx1 and Tx2 together with the receive antenna elements Rx1 and Rx2 of the first system on a chip SoC1 form a first antenna group and the transmit antenna elements Tx3 and Tx4 together with the receive antenna elements Rx3 and Rx4 of the second system on a chip SoC2 form a second antenna group. The two systems on a chip SoC1, SoC2 are symmetrical and configured in the same way. The geometry G of the antenna groups is known from the specification of the radar system RS and stored (see FIG. 2). The transceiver hierarchy of the T1 and T2 transceivers of the radar system RS is known as well.

FIG. 2 shows a flowchart of an embodiment of the method according to the present invention. To start, the radar system RS uses the antenna elements Rx1, Rx2, Rx3, Rx4, Tx1, Tx2, Tx3, Tx4 to carry out a measurement 10 of multiple targets in the surroundings. The measurement 10 is resolved by angle, in which case the surroundings are divided into angle cells by the antenna groups. The range and Doppler information 11 is then processed using a fast Fourier transformation. This is followed by a detection 12 of the targets within the angle cells. The energy is ascertained for each angle cell and a threshold value for the noise energy is ascertained, too. The ascertained energy is discriminated against the threshold value for the estimated noise energy in each cell. If multiple adjacent angle cells are above the threshold value for the estimated noise energy, the local maximums of the measured complex data are determined for each combination of the transmitters and the receivers.

The amplitude differences for the respective channels are compensated 20 for the self-calibration. For this purpose, the average receive power is calculated across all of the signal amplitudes according to Formula 2:

$$\vert \overline{x} \vert = \frac{1}{MN} {\sum }_{m = 1}^{M} {\sum }_{n = 1}^{N} \vert {\tilde{x}}_{mn} \vert \qquad ( Formula 2 )$$

|x̅| is the mean value of the amplitudes and \tilde{x}ₘₙ is the individual measured complex amplitudes. The totals across the transmitters m=1 . . . M and the receivers n=1 . . . N are summed.

The deviation of the amplitude from the average receive power is then calculated for each channel according to Formula 3:

$${\hat{A}}_{mn} = \frac{\vert {\tilde{x}}_{mn} \vert}{\vert \overline{x} \vert} \qquad ( Formula 3 )$$

The deviation is then used to compensate 20 an amplitude error for each channel.

A two-dimensional linear regression is carried out 21 for each antenna group of the systems on a chip SoC1, SoC2. In each case, the regression plane for which the mean square distance of the phase measurement values of the channels of the antenna groups becomes minimal is estimated. The geometry data G of the antenna groups are used in the two-dimensional regression. The difference between the measured phase value and the regression plane is now calculated for each channel. This provides the intragroup phase correction value for the respective antenna group. If the phase error is angle-dependent, each angle is calibrated 22 using a separate target. Intermediate angles for which there is no separate target are interpolated 23. If the phase error is not angle-dependent, the measured values of all targets are averaged 24 for each channel. This is now repeated for all of the antenna groups, so that intragroup phase correction values Kᵢₙₜᵣₐ are available for all of the (virtual) channels.

The distance between the two calculated regression planes of the two antenna groups of the first system on a chip SoC1 and the second systems on a chip is calculated 25 using modulo 21. This provides the intergroup phase correction value Kᵢₙₜₑᵣ for the two antenna groups.

Lastly, the control vectors of each channel are compensated 26 with the intragroup phase correction value Kᵢₙₜᵣₐ and the intergroup phase correction value Kᵢₙₜₑᵣ.

After the self-calibration, the reflection lists L can be used to carry out other evaluations such as an angle estimation 13.

1-7. (canceled)

8. A method for self-calibration of a radar system which includes at least two antenna groups to which at least one transmission channel and one receiving channel are assigned, the method comprising the following steps:
measuring a plurality of targets by the radar system;
processing range and Doppler information for each antenna group, and detecting the targets to obtain reflection lists with complex amplitudes for each target;
compensating amplitude differences for the channels;
using two-dimensional linear regression to estimate a regression plane for which a mean square distance of the phase measurement values of the channels of the antenna groups becomes minimal;
calculating a difference between the measured phase value and the regression plane for each channel to obtain an intragroup phase correction value;
calculating a distance between two regression planes of different antenna groups, with modulo 2π, to obtain an intergroup phase correction value; and
compensating control vectors of each channel with the intragroup phase correction value and the intergroup phase correction value.

9. The method according to claim 8, wherein measured values of all targets for each channel are averaged when calculating the intragroup phase correction value when there is no angular dependence of a phase error.

10. The method according to claim 8, wherein each angle is calibrated via a separate target when calculating the intragroup phase correction value when a phase error is angle-dependent.

11. The method according to claim 10, wherein intermediate angles for which there is no separate target are interpolated.

12. The method according to claim 8, wherein the range and Doppler information is processed using a fast Fourier transformation.

13. The method according to claim 8, wherein the detection of the targets is carried out using the following steps:
discriminating energy in each angle cell against a threshold value for an estimated noise energy; and
determining a local maximums when multiple adjacent angle cells are above the threshold value.

14. The method according to claim 8, wherein the compensation of the amplitude differences is carried out using the following steps:
calculating an average receive power;
calculating a deviation of the amplitude of each channel from the average receive power; and
compensating the amplitude based on the deviation.
